(19) United States
(12) Patent Application Publication
(10) Pub. No.: US 2002/0095880 A1
(43) Pub. Date: Jul. 25, 2002

(54) Pier with diagonal strut

(76) Inventor: Charles J. MacKarvich, Atlanta, GA (US)

Correspondence Address: George M. Thomas, Thomas, Kayden, Horstemeyer & Risley, 100 Galleria Parkway, N.W., #1750, Atlanta, GA, 30339-5948, US

(21) Appl. No.: 09/759,819

(22) Filed: Jan. 11, 2001

(51) Int. Cl. B60R 27/00; E04C 3/30

(52) U.S. Cl. 52/169.12; 52/170; 52/169.9; 52/693; 52/697; 52/695

(57) ABSTRACT

The support system for a premanufactured building includes a foundation platform (12) having cleat walls (50-53) that penetrate the ground. A support stand (14) and its vertical support shaft (30) function as a pier to support the joist (18) of the building. A diagonal stabilizing strut (16) is connected at its upper end to the same or to an adjacent joist, and at its lower end to the support stand, so that compression forces applied by the joist to the strut (16) move from one side of the vertical load axis (28) to the other side of the axis and engage the foundation platform, so that the ground adjacent the cleats (50-53) resists movement of the joist.

### FIELD OF THE INVENTION

This invention relates to a support system for a premanufactured building of the type that has parallel support joists positioned above the ground that support the building, with piers extending between the surface of the ground and the joists for supporting the joists. More specifically, this invention relates to a pier and diagonal strut assembly where the pier supports one joist of the building and the diagonal strut can be extended from the pier diagonally upwardly to the same joist or to an adjacent joist to resist longitudinal or lateral movement of the building in response to wind forces and the like.

### BACKGROUND OF THE INVENTION

Premanufactured buildings, such as mobile homes, trailers, prefabricated houses, and the like are manufactured at a central manufacturing site and, upon completion, the buildings are moved to a location where they are to be permanently located and occupied. Because these buildings are designed to be easily moved from the manufacturing site to the permanent location, they are not originally built on a permanent foundation at the manufacturing site. Typically, the premanufactured homes are built on a pair of parallel I-beam support joists, and then the manufactured building is temporarily mounted on wheels and transported to and mounted upon piers, such as concrete blocks, pilings, jack stands, etc. at a site where the building will be used. The wheels are mounted to the parallel support joists so as to facilitate moving the building, and when the building arrives at its site of erection, the piers are strategically placed on the ground and the building is lowered toward the piers until the parallel support joists rest on the piers. The wheels are removed and reused for transporting another building.

It is important that the building also be anchored in position on the piers at the site of erection of the building so as to avoid the building being shifted off of its piers by strong winds or earth tremors. A building inadvertently shifted off of its piers usually is seriously damaged.

Various types of ground anchors with tie-down straps and various other stabilizing devices have been used to hold premanufactured building structures in place, to keep the buildings from moving in response to wind forces and earth movement. A traditional approach to provide lateral wind protection for manufactured buildings includes the use of ground anchors each having a shaft with one or more helical plates at the bottom of the shaft which can be rotated to move into the earth. Cold-rolled steel strapping is installed as diagonal ties between the upper exposed portion of the anchor and the lower main frame of the manufactured building, so as to apply downward lateral forces to the support joists of the building, to avoid upward movement of the building in response to wind lift and to avoid lateral movement of the building by the lateral wind forces, and ground tremors. A system of this type is taught in U.S. Pat. No. 3,747,288.

In addition, a stabilizing system has been developed, as taught by U.S. Pat. No. 6,058,663, that uses struts extending diagonally between a foundation platform beneath the building and a joist of the building to stabilize the building against horizontal movement. The foundation platform utilizes ground penetrating cleats to avoid movement of the platform when forces are applied to it. When the joist tends to move toward the foundation platform, its movement is resisted by the diagonal strut that applies the forces from the joist to the platform, and through the cleats of the platform to the ground.

While the above noted systems have been successful, there still remains a need for a portable pier structure for securely supporting the joists of a premanufactured home in the field, with the pier structure being inexpensive to construct, strong enough to provide the desired support features, arranged to resist either longitudinal or lateral movement of the building structure, and expedient to install.

### SUMMARY OF THE INVENTION

Briefly described, the present invention comprises a longitudinal stabilizing system for a premanufactured building with the building being of the type that has parallel support joists extending along the length of the underside of the building and being supported above the ground by upright piers. The system is utilized to retard movement of the building along the length of the support joists and/or across the length of the support joists during exposure to winds or other external forces.

The system includes a foundation platform for placement beneath a joist of the building, a pier resting on the foundation platform and arranged to support the joist of the building. The load applied by the building to the pier and foundation platform establishes a vertical load axis. A diagonal strut slopes from intermediate the height of the pier on one side of the vertical load axis upwardly to the same or the adjacent joist of the building. In addition, the pier includes a diagonal support that extends opposite to the diagonal strut on the other side of the load axis, downwardly from intermediate the height of the pier into load bearing engagement with the foundation platform. The diagonal strut and the diagonal support effectively form a diagonal support assembly extending from a joist of the building structure to the pier, and then from the pier to the foundation platform. In addition, cleats are formed on the foundation platform that penetrate the ground. With this arrangement, any compressive force applied by the joist to the diagonal stabilizing strut is transmitted through the diagonal support assembly to the foundation platform, and then from the foundation platform through its cleats into the ground. Thus, the ground opposes the movement of the pier and the building.

In the embodiments of the invention disclosed herein, a support stand with diagonal legs and a vertical support shaft is used as the pier, with one of the legs of the support stand diametrically opposed to the diagonal stabilizing strut. This forms the diagonal support assembly.

Thus, it is an object of this invention to provide an improved support system for a premanufactured building which is expedient to install, inexpensive to manufacture, and which functions to resist movement of a support joist of the building.

Another object of this invention is to provide a support system for such a building which includes a pier that having a support stand with sloped legs mounted on a foundation platform and a vertical support that is adjustable in height with respect to the support stand for supporting a pier of a premanufactured building and, in addition, a diagonal stabilizing strut extending from the support stand sloped upwardly for engagement with the joist of the building, which resists any compressive forces applied to it by the joist of the building.

Another object of the invention is to provide an improved support system for premanufactured buildings that includes an adjustable pier that can be can be expediently mounted to the building and that provides horizontal support for the building.

Other objects, features, and advantages of the present invention will become apparent upon reading the following specifications, when taken in conjunction with the accompanying drawings.

### BRIEF DESCRIPTION OF THE DRAWINGS

FIG. 1 is a side elevational view of the support system which, in this embodiment, includes a pier formed from a two legged support stand with a vertical support shaft, mounted on a foundation platform, with a diagonal stabilizing strut extending from the support stand upwardly to the joist of the building.

FIG. 2 is a front elevational view of the support system of FIG. 1.

FIG. 3 is a side elevational view, of the support system, similar to FIG. 1, but showing the diagonal stabilizing strut extending to an adjacent joist of the building structure. A portion of the strut has been removed from the drawing to reduce the size of the drawing.

FIG. 4 is a side elevational view of a support system, similar to FIG. 1, but showing a three legged support stand.

FIG. 5 is a perspective illustration of the support stand of FIG. 4.

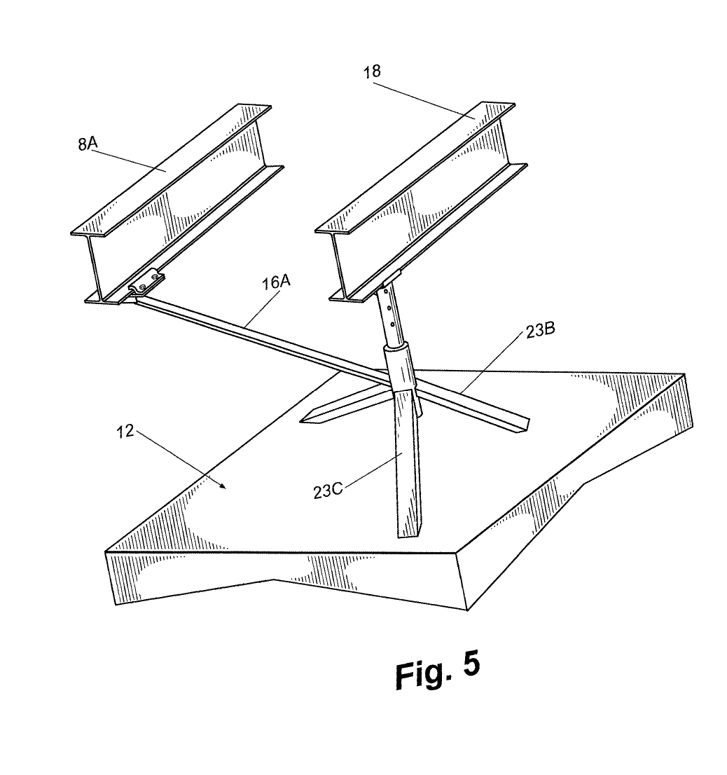

### DETAILED DESCRIPTION

Referring now in more detail to the drawings in which like numerals indicate like parts throughout the several views, the support system 10 includes a foundation platform 12, a pier 14 and a diagonal stabilizing strut 16. The pier is mounted beneath a joist 18 of a premanufactured building (the whole building is not shown), in supporting relationship with the joist. Typically, the joist is an I-beam supported above the surface of the ground 20 by the pier 14 and other piers.

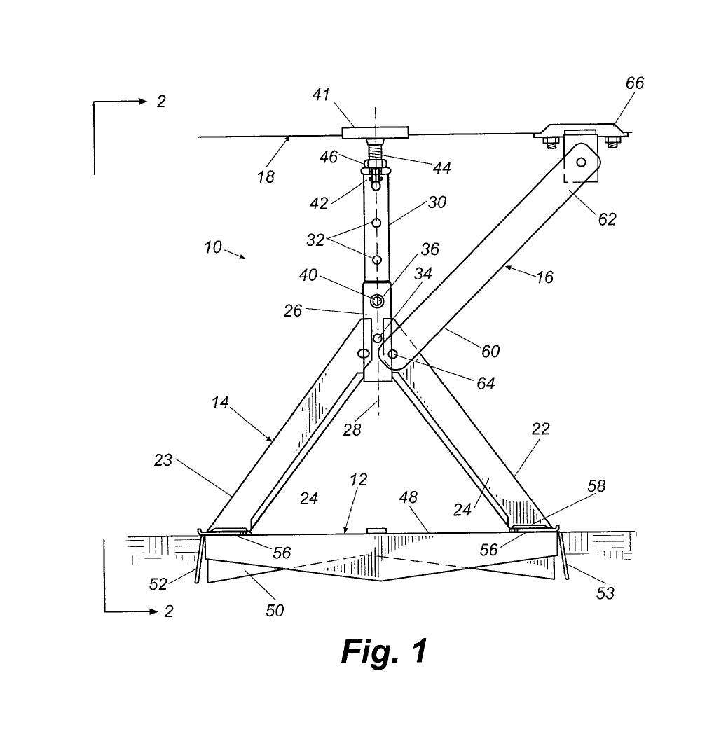

Pier 14 is, in this embodiment, a support stand having two or more diverging support legs 22 and 23. In the embodiments shown in FIGS. 1-3, the support stand has two legs 22 and 23 positioned in a common vertical plane, with the legs being of identical construction. The lower ends of the legs are formed at an angle with respect to the length of the legs so as to rest flat against the foundation platform. Preferably, the legs are formed of channel-shaped steel of a gauge sufficient to function as a weight support, with a weight capacity of the assembly exceeding 2000 lbs.

Tubular shaft support 26 is joined to the upper ends of the support legs 22 and 23 and is joined thereto by welding or other rigid fastening means. The tubular shaft support has its longitudinal axis 28 extending vertically.

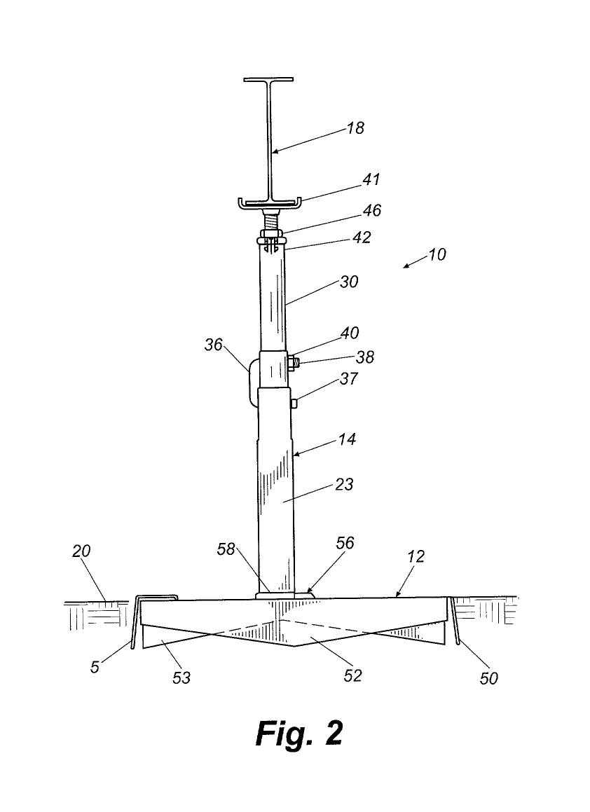

Vertical support shaft 30 is telescopically received in the tubular shaft support 26. Shaft 30 includes a series of equally spaced openings 32, and tubular shaft support 26 has similar openings 34. The vertical support shaft 30 is locked into position in the tubular shaft support 26 by the use of a U-shaped lock 36. The lock has parallel legs 37 and 38 (FIG. 2) that are inserted through aligned ones of the openings 32 and 34 of the tubular shaft support 26 and the vertical support shaft 30. A cotter pin, threaded nut, or other conventional keeper 40 is applied to one of the exposed ends 37 or 38 of the U-shaped lock 36 so as to hold the U-shaped lock in place. With this arrangement, the vertical support shaft 30 is rigidly mounted to the legs of the support stand 14.

A support plate 41 is mounted to the upper end 42 of the vertical support shaft 30. A threaded stud 44 extends downwardly from the plate 41into the shaft, with adjustment nut 46 engaging the threads of the stud. Rotation of the adjustment nut moves the threaded stud and its support plate 41 vertically with respect to the vertical support shaft 30.

With this arrangement, when the support stand 14 is mounted on the foundation platform 12 beneath the joist 18, the support platform is positioned beneath the joist. The threaded adjustment nut can then be rotated to lift the support plate 41 up into load bearing engagement with the joist 18.

Foundation platform 12 is formed from a single sheet of material, typically a corrosive resistant metal, such as treated steel. The foundation platform includes a substantially flat body portion 48 and the side edges of the platform are turned at approximately right angles with respect to the flat body portion, forming cleat walls 50-53. In the disclosed embodiment, the flat body portion 48 of the foundation platform is rectangular, so that the cleat walls 50-53 are arranged at right angles with respect to one another. When the foundation platform 12 is to be placed beneath a joist 18, its cleat walls 50-53 are urged into the ground 20 until the body portion 48 engages the ground. The ground adjacent the cleat walls 50-53 retard any horizontal movement of the foundation platform.

In order to maintain the diverging support legs 22 and 23 of the support stand in position on the foundation platform, the legs each include a laterally extending tab 56, and the foundation platform 12 includes a U-shaped strap 58 that is struck from the flat body portion 48 of the foundation platform. The tabs 56 of the support legs 22 and 23 of the support stand 14 are telescopically inserted into the U-shaped straps 58. This holds the bottom portions of the support legs 22 in place on the foundation platform, and locates the support stand properly on the foundation platform, intermediate the opposed cleats 50 and 51.

Diagonal stabilizing strut 16 includes a lower end 60 and an upper end 62, with the lower end pivotally connected to diverging support leg 22 of the support stand 14, by means of a bolt 64 extending through aligned openings of the elements. The upper end 62 of the strut 16 is mounted to the joist 18 by means of a clamp attachment 66. Clamp attachment 66 and foundation platform 12 are disclosed in more detail in U.S. Pat. No. 6,058,663, the disclosure of which is incorporated herein by reference.

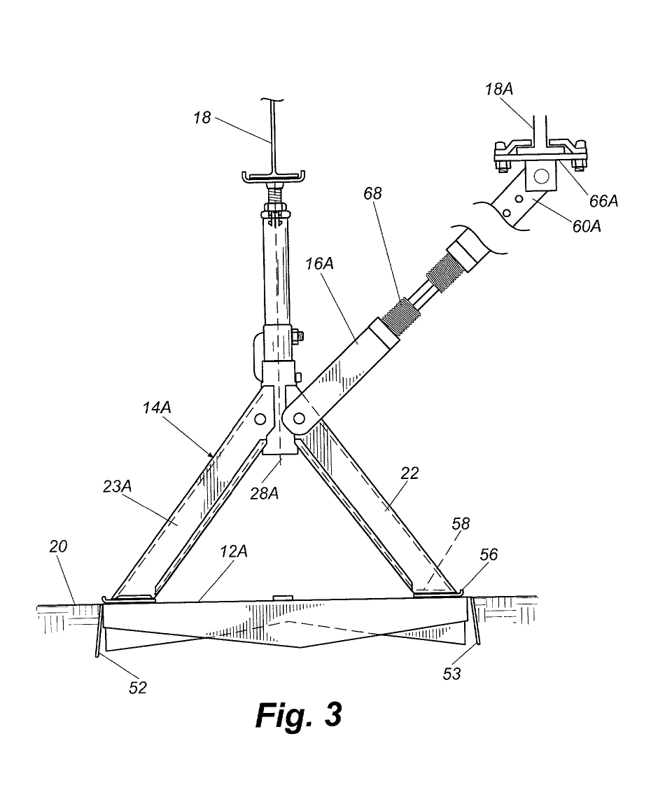

While FIGS. 1 and 2 show the pier in the form of a support stand 14 and its diagonal stabilizing strut 16 attached to a common joist 18, FIG. 3 discloses the same support stand but turned 90° with respect to the joist 18. The diagonal stabilizing strut 16 is replaced with a longer diagonal stabilizing strut 16A, and the strut extends from beneath the joist 18 laterally over to the next adjacent parallel joist 18A. The upper end 60A of the strut 16A is connected to the joist by means of a joist connector 66A.

Typically, strut 16A can be adjustable in length by means of a turnbuckle connection 68 or an equivalent conventional length adjustment feature.

In FIG. 1, it will be noted that the stabilizing strut 16 and the diverging support leg 23 are approximately parallel to each other. The stabilizing strut 16 is on one side of the vertical load axis 28 and the opposed diverging support leg 23 is on the opposite side of the vertical load axis. In the embodiments of FIGS. 1-3, where the support stand is a bipod, the opposed diverging support leg 22 is positioned in a common vertical plane with stabilizing strut 16. The lower end of the stabilizing strut is attached to the support stand intermediate the height of the support stand and, likewise, the opposed diverging support leg 22 is connected to the tubular shaft support 26 at a position that is also intermediate the height of the support stand.

With this arrangement, the diagonal stabilizing strut 16, the opposed diverging support leg 22, and the portion of the tubular shaft support 26 at their juxtaposed connections to the tubular shaft support form a diagonal support assembly that extends between the joist 18 of the building structure on one side of the vertical load axis 28 and the foundation platform 12 on the other side of the vertical load axis. With this arrangement, if the joist 18 tends to shift with respect to the support system so as to apply compressive forces on the diagonal stabilizing strut 16, those forces are transmitted from the strut 16, through the tubular shaft support 26 of the pier, through the opposed divergent support leg 23 of the pier, to the foundation platform 12. Because of the rigid mount of the pier on the platform 12, the force continues to be transmitted from the pier through the foundation platform 12 to its cleats 52 and 53 that are oriented transverse to the stabilizing strut 16. With this arrangement, the longitudinal compressive forces are transmitted from the joist 18 to the ground, through the cleats 52 and 53, so that the ground resists movement of the joist 18.

A similar resistance to compressive forces on stabilizing strut 16A is provided by the support stand 14A, with the compressive forces being transmitted from the strut 16A through the tubular shaft support 26 and across the vertical load axis 28 to the opposed diverging support leg 23A to the foundation platform 12A, and from the platform through its cleat walls to the ground. This resists the lateral movement of the adjacent joist 18A toward the pier 14.

In both embodiments of FIGS. 1 and 3, it will be noted that the weight of the prefabricated building is mounted on the pier 14 and on its foundation platform 12, so as to provide an extremely strong structure for resisting lateral forces that might be applied through the diagonal stabilizing strut 16 or 16A. The forces applied by either joist 18 (FIG. 1) or 18A (FIG. 3) are applied from one side of the vertical load axis 28, 28A of the support stand to the other side of the axis, where the lower end of the opposed divergent support leg 23 or 23A engages the foundation platform.

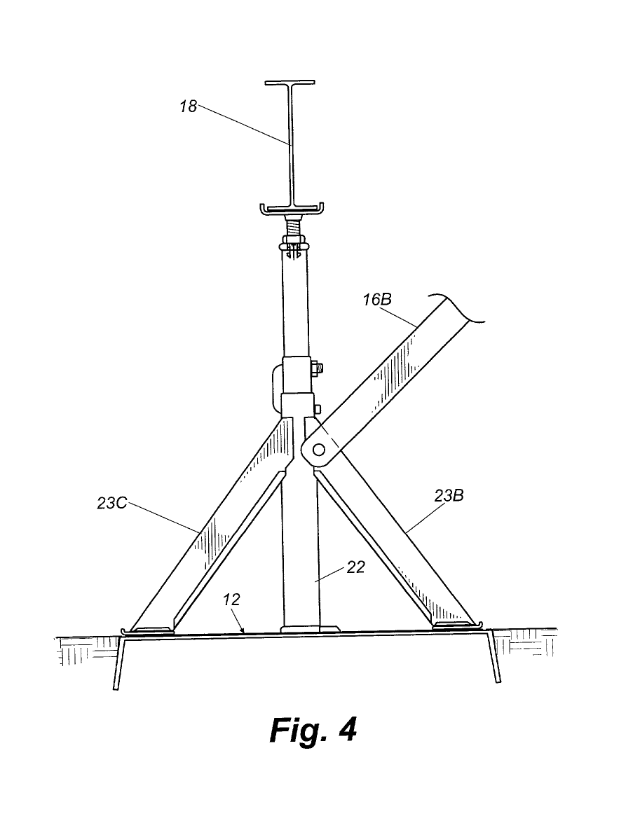

As illustrated in FIG. 4, the pier which has been illustrated in FIGS. 1-3 in the form of a two-legged support stand is now shown as being a tripod, having three legs with the divergent support leg being replaced with a pair of divergent support legs 23B and 23C. The support legs 23B and 23C straddle the vertical plane and the line of force of strut 16B. The pair of legs 23B and 23C provide additional stability to the pier structure and additional strength in resisting the forces applied by the diagonal stabilizing strut 16A.

Also, various other shapes of piers can be utilized in the practice of the invention. While support stands having divergent legs have been illustrated as the preferred embodiment, other support stands can be utilized as long as they include a combination of a diagonal stabilizing strut and an opposed diverging support extending on opposite sides of the vertical load axis of the pier. This could be embodied in a monolithic structure or a sheet metal pyramidal structure, conical structure, or other structures embracing the principles of the invention. Also, while the cleat walls 50-53 of the foundation platform have been illustrated as sheet material, other cleat configurations can be utilized as long as the cleats provide sufficient resistance to horizontal movement of the foundation platform through the ground material.

It will be understood by those skilled in the art that while the foregoing description sets forth in detail preferred embodiments of the present invention, modifications, additions, and changes might be made thereto without departing from the spirit and scope of the invention, as set forth in the following claims.

1. A support system for a premanufactured building having horizontally extending parallel support joists positioned above the ground, said support system comprising:
a foundation platform for placement on the surface of the ground beneath a joist of the building;
a pier having first and second opposed sides, a lower end positioned on said foundation platform and an upper end adapted to support a joist of the building;
a stabilizing strut having a lower end connected to said pier at a connection position intermediate said upper and lower ends of the pier and sloped upwardly from said first side of said pier and adapted at its upper end for rigid connection to a joist of the building;
said pier including diagonal support means positioned on said second side of said pier opposite to the sloped stabilizing strut and extending from adjacent said connection position of said stabilizing strut on said pier in a downward sloped direction approximately aligned with said stabilizing strut to said foundation platform to form with said stabilizing strut a diagonal support assembly extending between said foundation platform and the joist of the building;
so that compressive forces applied from the joist of the building to the stabilizing strut are transmitted through said pier and through said diagonal support means to the foundation platform.

2. The support system of claim 1, wherein said stabilizing strut and said diagonal support means are positioned in a common vertical plan.

3. The support system of claim 1, wherein said pier is a tripod with a vertical support shaft movably mounted on said tripod.

4. The support system of claim 1, wherein said pier is a bipod with a vertical support shaft movably mounted on said bipod.

5. The support system of claim 1, wherein said pier comprises an adjustable jack stand.

6. The support system of claim 5, wherein said jack stand includes a support stand having sloped legs with lower ends spread from one another and mounted on said foundation platform and with juxtaposed upper ends, and a vertical support shaft extending upwardly from said juxtaposed upper ends of said support stand for engaging a joist of the building, and one of said sloped legs comprising said diagonal support means approximately aligned with said stabilizing strut.

7. The support system of claim 6, wherein said stabilizing strut extends from said support stand.

8. The support system of claim 1 further including a cleat extending normal to said foundation platform and penetrating the ground.

9. The support system of claim 1, wherein said foundation platform is formed of sheet material with a body portion for placement on the ground and at least one cleat wall extending normal to said body portion and penetrating the ground and oriented transverse to said stabilizing strut, so that compressive forces transmitted through said strut and said diagonal support means to said foundation platform are transmitted through the cleat wall to the ground.

10. The support system of claim 1, wherein said pier is adapted to be positioned beneath one of the joists of the building and said stabilizing strut is adapted to be mounted to another one of said support joists, so that the stabilizing strut and said diagonal support means resist movement of the building in a direction transverse to the lengths of the joists of the building.

11. The support system of claim 1, wherein said pier is adapted to be positioned beneath one of the joists of the building and said stabilizing strut is adapted to be mounted to said one of the joists, so that the stabilizing strut and said diagonal support means resist movement of the building in a direction parallel to the lengths of the joists of the building.

12. The support system of claim 1, wherein said pier is a support stand with a pair of diverging legs oriented in a common plane and adapted to be positioned in a plane parallel to a support joist of the building.

13. A support system for a building, the building having first and second horizontally extending parallel support joists for supporting the building above a ground surface, said support system comprising:
a foundation platform;
a support stand having a lower end mounted on said foundation platform and an upper end;
a vertical support shaft mounted on said upper end of said support stand and having a distal end positioned upwardly from said support stand adapted to support a joist of the building;
a stabilizing strut having a lower end mounted to said support stand at a connection position adjacent said vertical support shaft and sloped upwardly from said support stand and having an upper end adapted for connection to a support joist of the building;
said support stand having a sloped leg with an upper end positioned adjacent said connection position of said stabilizing strut and sloped downwardly from adjacent and extending substantially in a common plane with said stabilizing strut and having a lower end mounted on said foundation platform,
so that compressive forces applied from a joist of the building to the stabilizing strut are transmitted through the sloped leg to the foundation platform.

14. The support system of claim 13 wherein said stabilizing strut and said sloped leg are positioned in a common vertical plane.

15. The support system of claim 13 wherein said support stand is a bipod.

16. The support system of claim 13, wherein said foundation platform includes cleat walls, and at least one of said cleat walls is oriented transverse to said stabilizing strut and to said sloped leg so that compressive forces applied from a joist of the building to the stabilizing strut are transmitted through the sloped leg to the cleat wall of the foundation platform to the ground and the ground resists movement of the joist of the building.

17. The support system of claim 16, wherein said foundation platform is formed of sheet material, and includes a body portion for placement on the surface of the ground on which said support stand is mounted and said cleat walls are formed from edge portions of said foundation plate extending normal to said body portion for insertion into the ground.

18. A support system for a premanufactured building having horizontally extending parallel support joists positioned above the ground, said support system comprising:
a foundation platform having cleats for penetrating the ground,
a pier having a lower end mounted on said foundation platform having an upper end adapted to support a joist of the building with the joist applying a vertical load on a vertical axis extending through said pier and extending through said foundation platform to the ground beneath said foundation platform,
a diagonal stabilizing strut having a lower end connected to said pier at a connection point intermediate said upper and lower ends of said pier and sloped upwardly on one side of said vertical load axis and adapted at its upper end for rigid connection to a joist of the building.
said pier including diagonal support means positioned on the other side of said load axis extending to said foundation platform to form with said strut a diagonal support assembly sloped downwardly between the joist and said foundation platform across the load axis,
so that compressive forces applied from the joist of the building to the stabilizing strut are transmitted from the stabilizing strut through said pier, across said load axis and through said diagonal support means, through said foundation platform and from a cleat into the ground.
